(19) United States
(12) Patent Application Publication
(10) Pub. No.: US 2026/0369223 A1
(43) Pub. Date: Nov. 19, 2026

(54) OLED DISPLAY DEVICE AND TEMPERATURE PROTECTION DEVICE AND METHOD THEREOF

(71) Applicant: CHIPONE TECHNOLOGY (ZHUHAI) CO., LTD., Zhuhai (CN)

(72) Inventor: Pinyan GUO, Zhuhai (CN)

(73) Assignee: Chipone Technology (Beijing) Co., Ltd., Zhuhai, CN (CN)

(21) Appl. No.: 19/124,211

(22) PCT Filed: Aug. 8, 2023
(86) PCT No.: PCT/CN2023/111610

§ 371 Date: Apr. 24, 2025

(30) Foreign Application Priority Data
Oct. 24, 2022 (CN) 202211301847.4

(51) Int. Cl. G09G 3/3208

(52) U.S. Cl. CPC G09G 3/3208; G09G 2330/021; G09G 2330/045

(57) ABSTRACT

The present disclosure provides an OLED display device and temperature protection device and method thereof. The temperature protection method comprises: detecting an ambient temperature of the display device; sending a voltage control signal to a power supply module according to a temperature signal that is detected; wherein when the ambient temperature is in a predetermined range, a first voltage provided by the power supply module to a light emitting device in the display device is adjusted by the voltage control signal. The corresponding voltage control signal is obtained at different ambient temperatures to control a voltage value of the first voltage, so as to control a current flowing through the light emitting device, ensuring that the display device will not be damaged by an excessive current generated by a high temperature.

This application claims priority to the Chinese Patent Application No. 202211301847.4, filed on Oct. 24, 2022, entitled “OLED display device and temperature protection device and method thereof”, which is incorporated herein by reference in its entirety in this disclosure, including the specification, claims, drawings and abstract.

### FIELD OF TECHNOLOGY

The present disclosure relates to a technical field of organic light emitting display, and in particular, to an organic light emitting diode (OLED) display device and temperature protection device and method thereof.

### DESCRIPTION OF THE RELATED ART

In display technology, organic light emitting diode (OLED) display with advantages of thin, active light, fast response speed, wide viewing angle, rich color and high brightness, high and low temperature resistance, and etc. is recognized by the industry as a third generation of display technology after liquid crystal display (LCD).

When an OLED display device displays an image, since the light emitting device is particularly sensitive to temperature changes, light emitting devices on different processes have different current and voltage characteristic curves. When an operating temperature of the display device rises, with a condition of cross voltages of OLED are the same, a current density of OLED rises. When the current density rises, it enhances the heat generation of the OLED display device, which further causes the temperature of the OLED display device to rise. Then the characteristic curve changes again, and the current increases again. Thus, a vicious cycle of increasing current is formed, which not only causes additional power consumption, but also reduces life of the OLED display device with the excessive current.

### SUMMARY OF THE INVENTION

In view of the above problems, an objective of the present disclosure is to provide an organic light emitting diode (OLED) display device and temperature protection device and method thereof, so as to solve technical defects mentioned in the prior art.

According to an aspect of the present disclosure, there is provided a temperature protection method in OLED display device, comprising:
detecting an ambient temperature of the display device;
sending a voltage control signal to a power supply module according to a temperature signal that is detected;
wherein when the ambient temperature is in a predetermined range, a first voltage provided by the power supply module to a light emitting device in the display device is adjusted by the voltage control signal.

Optionally, controlling the power supply module power-down by the voltage control signal when the ambient temperature is in a non-predetermined range.

Optionally, before sending the voltage control signal to the power supply module according to the temperature signal that is detected, further comprises: obtaining current-voltage characteristic curves of the light emitting device in the display device at different ambient temperatures, and importing them into an overheat protection module; establishing a temperature feedback parameter control model of the light emitting device; obtaining a corresponding voltage control signal according to the temperature signal that is detected according to the temperature feedback parameter control model.

Optionally, the temperature feedback parameter control model is a control curve of relationship of the first voltage changing with temperature.

Optionally, when the ambient temperature rises in the predetermined range, a slope of the relationship of the first voltage changing with temperature is adjusted, and a current of the light emitting device with adjusted first voltage is consistent with a normal operating current.

Optionally, on a basis of the current of the light emitting device with adjusted first voltage is consistent with a normal operating current, the slope of the relationship of the first voltage changing with temperature is increased, and the current of the light emitting device with adjusted first voltage is less than the normal operating current.

Optionally, the predetermined range is greater than or equal to 30 °C and less than or equal to 50 °C, and the non-predetermined range is greater than 50 °C.

Optionally, a step of establishing the temperature feedback parameter control model of the light emitting device comprises: placing the light emitting device in different ambient temperatures in advance to obtain its parameters when working in different ambient temperatures.

According to another aspect of the present disclosure, there is provided a temperature protection device in OLED display device, comprising: a temperature detection element and an overheat protection module, the temperature detection element is configured to detect an ambient temperature of the display device, and send a temperature signal that is detected to the overheat protection module; the overheat protection module is configured to send a voltage control signal to a power supply module according to the temperature signal that is detected, and adjust a first voltage provided by the power supply module to a light emitting device in the display device by the voltage control signal.

According to another again aspect of the present disclosure, there is provided an OLED display device, comprising a temperature protection device in OLED display device above mentioned, wherein an OLED array in the OLED display device comprises any one of micro OELD and AMOLED.

The temperature protection method provided by the present disclosure obtains current-voltage characteristic curves of the light emitting device in the display device at different ambient temperatures in advance, imports them into the overheat protection module to establish the temperature feedback parameter control model of the light emitting device, and then obtains the corresponding voltage control signal Va under different ambient temperatures with reference to the temperature feedback parameter control model to control a voltage value of the first voltage VDD, so as to control the current of the light emitting device. In a preferred embodiment, the slope of the relationship of the first voltage changing with temperature in the temperature feedback parameter control model is changed, so as to realize constant current control or overcurrent control of the light emitting device.

### BRIEF DESCRIPTION OF THE DRAWINGS

Through the following description of the embodiments of the present disclosure with reference to the accompanying drawings, the above and other objectives, features, and advantages of the present disclosure will be more apparent, and in the drawings:

FIG. 1 is a schematic diagram of a structure of an OLED display device according to prior art;

FIG. 2a is a schematic diagram of a structure of an OLED display device according to embodiments of the present disclosure;

FIG. 2b is a flowchart of a temperature protection method of an OLED display device according to embodiments of the present disclosure;

FIG. 3 is a flowchart of a method of changing a cross voltage of a light emitting device according to embodiments of the present disclosure;

FIG. 4 is a schematic diagram of current density-voltage characteristic curve of a light emitting device according to embodiments of the present disclosure;

FIG. 5 is a control model curve of a first voltage VDD changing with temperature according to embodiments of the present disclosure;

FIG. 6 is a schematic diagram of relationship of current changing with time of a light emitting device before and after treatment by a temperature protection device according to embodiments of the present disclosure;

FIG. 7 is a schematic diagram of relationship of an ambient temperature changing with time of a display device before and after treatment with constant current control of a temperature protection device according to embodiments of the present disclosure.

### DETAILED DESCRIPTION OF THE DISCLOSURE

The present disclosure will be described in greater detail below with reference to the accompanying drawings. In the various accompanying drawings, the same elements are represented using same or similar symbols. For clarity, portions of the accompanying drawings are not drawn to scale.

It should be understood that, in following description, “circuit” may comprise single or multiple combinations of hardware circuits, programmable circuits, state machine circuits, and/or elements capable of storing instructions that are executed by programmable circuits. When an element/circuit is “connected to” another element, or the element/circuit is “connected between” two nodes, it may be directly coupled or connected to another element or there may be intermediate elements. The connection between elements can be physical, logical, or a combination thereof. Conversely, when an element is “directly coupled to” or “directly connected to” another element, no intermediate elements are connected between the two elements.

At the same time, certain terms are used in the specification and claims of the present disclosure to refer to specific components. It should be appreciated by one of ordinary skill in the art that a hardware manufacturer may use different terms to refer to the same component. The specification and claims of the present disclosure do not distinguish components by differences in name, but rather by differences in function.

In addition, it should be noted that relational terms such as first and second etc. are used herein only to distinguish one entity or operation from another and do not necessarily require or imply any such actual relationship or order between these entities or operations. Moreover, the terms “comprise”, “composed of” or any other variation thereof are intended to encompass non-exclusive inclusion, so that a process, method, article or equipment that comprises a set of elements comprises not only those elements but also other elements that are not explicitly listed or are inherent to such a process, method, article or equipment. In the absence of more restrictions, an element defined by a statement “comprises a . . . ”does not preclude the existence of another identical element in the process, method, article or equipment that comprises the said element.

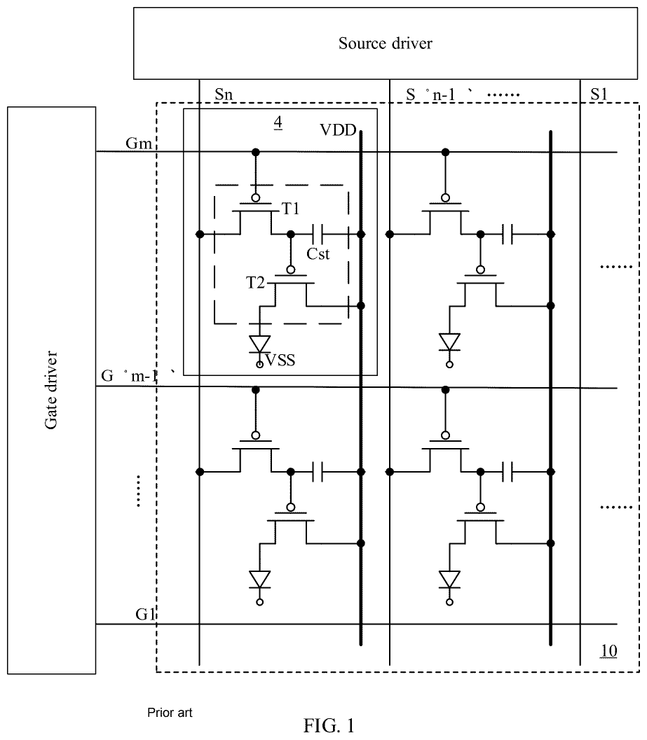

FIG. 1 is a schematic diagram of a structure of an OLED display device according to prior art.

As shown in FIG. 1, an OLED display device in the prior art comprises a display panel 10, a source driver and a gate driver. The display panel 10 comprises a plurality of gate lines G1-Gm, a plurality of data lines S1-Sn, and a plurality of pixel regions 4 comprising an organic light emitting diode OLED. The gate driver is used to provide a gate voltage to the display panel 10 through the plurality of gate lines G1-Gm in a display state. The source driver is used to provide a source data voltage (also known as a grayscale voltage) to the display panel 10 through a plurality of data lines in the display state. With control of the gate voltage, pixel regions connected to the same data line in the plurality of pixel regions 4 can emit light of the same color. For example, light of any one of red, green, blue or another color may be emitted.

When the above-mentioned OLED display device operates, since the light emitting device is particularly sensitive to temperature changes, when an operating temperature of the OLED display device rises, with a condition of cross voltages of OLED are the same, a current density of OLED rises. When the current density rises, it enhances the heat generation of the OLED display device, which further causes the temperature of the OLED display device to rise. Then a characteristic curve changes again, and the current increases again. Thus, a vicious cycle of increasing current is formed, which not only causes additional power consumption, but also reduces life of the OLED display device with the excessive current.

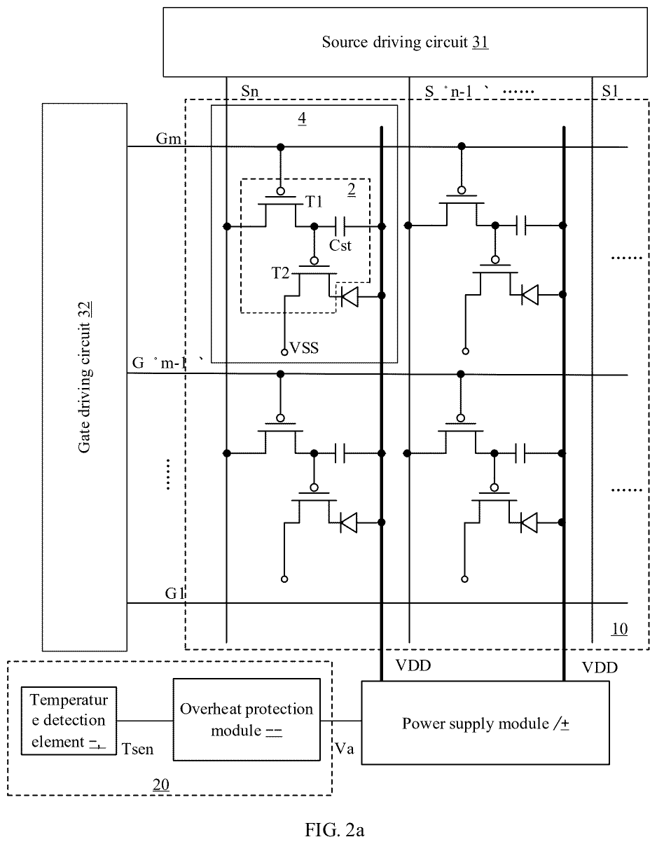

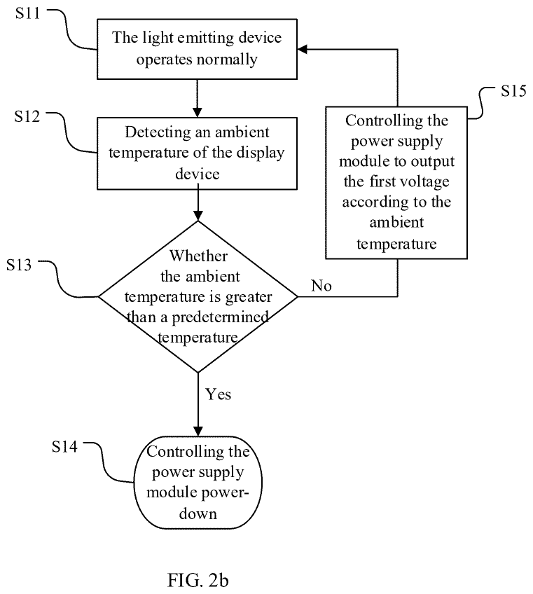

FIG. 2a is a schematic diagram of a structure of an OLED display device according to embodiments of the present disclosure.

As shown in FIG. 2a, an OLED display device according to embodiments of the present disclosure comprises a display panel 10, a display driving module and a temperature protection module 20.

The display panel 10 comprises a plurality of gate lines G1-Gm, a plurality of data lines S1-Sn, and a plurality of pixel regions 4, wherein the plurality of pixel regions 4 comprise a plurality of pixel units 2, a plurality of organic light emitting diode OLED, and a plurality of cathode electrodes (not shown in the drawings) which are corresponding to the plurality of pixel regions 4, and m and n are positive integers. The display driving module comprises a power supply module 40. The power supply module 40 is connected to the display panel 10 for providing a first voltage VDD to the display panel 10. Wherein, the pixel region 4 is connected to the gate line Gm, the data line Sn and the first voltage VDD.

In this embodiment, the pixel region 4 of the display panel 10 comprises the organic light emitting diode OLED and the pixel unit 2 which is connected to the gate line Gm and the data line Sn to control the OLED. Wherein, a cathode of the OLED is connected to the pixel unit 2, and an anode of the OLED is connected to the first voltage VDD.

Wherein, the pixel unit 2 controls an amount of current provided to the OLED according to a data signal provided to the data line Sn when a scanning signal is sent to the gate line Gm, and the OLED generates light of a predetermined brightness according to the current provided by the pixel unit 2.

The display driving module is used to provide a scanning signal and data signal to the display panel in the display state to drive the touch display panel to display. Wherein, the display driving module comprises a gate driving circuit 32 for providing a gate voltage to the display panel 10 in the display state; and a source driving circuit 31 for providing a grayscale voltage to the display panel 10 in the display state.

The OLED display device of the present disclosure further comprises an over-temperature compensation system 20 for automatically adjusting the first voltage VDD provided to the display panel 10 according to an ambient temperature of the display panel 10.

Wherein, the temperature protection device 20 comprises a temperature detection element 21 and an overheat protection module 22.

The temperature detection element 21 is used to detect the ambient temperature of the light emitting device (i.e., the above-mentioned OLED) and send a temperature signal Tsen to the overheat protection module 22. The temperature detection element is, for example, a temperature measuring element such as a temperature sensitive resistor, a thermocouple, a thermometer, and so on, which no limitation is made in the present disclosure.

The overheat protection module 22 is used to provide a voltage control signal Va to the power supply module 40 according to the temperature signal Tsen, to control a voltage value of the first voltage VDD provided by the power supply module 40 to the display panel 10.

FIG. 2b is a flowchart of a temperature protection method of an OLED display device according to embodiments of the present disclosure.

As shown in FIG. 2b and with reference to FIG. 2a, in this embodiment, the temperature detection element 21 and the overheat protection module 22 of the temperature protection device 20 perform steps of a temperature protection method together. For example, during the OLED display device displaying, the temperature protection device 20 performs steps S11 to S15 as detailed below.

In step S11, the light emitting device operates normally.

In this step, the light emitting device, e.g., the OLED in the pixel region 4 described above, operates normally in an initial state.

In step S12, detecting an ambient temperature of the display device.

In this step, the ambient temperature of the display device is detected by the temperature detection element 21 of the temperature protection device 20.

In this embodiment, the temperature detection element is arranged on a backside of a encapsulation layer of the light emitting device in the OLED display device for detecting the ambient temperature of the display device. The temperature detection element 21 is connected to the overheat protection module 22 to send the temperature signal Tsen of the ambient temperature to the overheat protection module 22.

In step S13, determining whether the ambient temperature is greater than a predetermined temperature.

In this step, if the ambient temperature is less than or equal to the predetermined temperature, a temperature of the light emitting device is determined to be within a predetermined range, and step S15 is performed. If the ambient temperature is greater than the predetermined temperature, the temperature of the light emitting device is determined to be too high and is in a non-predetermined range, for example, being greater than 50 °C The OLED display device working at such a temperature would reduce a life of the OLED display device, and step S14 is performed.

In step S14, controlling the power supply module power-down.

In this step, the overheat protection module 22 sends the voltage control signal Va to the power supply module 40 according to the temperature signal Tsen. When the ambient temperature is too high, the voltage control signal Va controls the power supply module 40 power-down, so that the display device stops working and forces the system to enter a dormant state to ensure that the device is not damaged by an excessive current generated by the high temperature.

In step S15, controlling the power supply module to output the first voltage according to the ambient temperature.

In this step, the overheat protection module 22 sends the voltage control signal Va to the power supply module 40 according to the temperature signal Tsen. When the ambient temperature is within the predetermined range, for example, being greater than or equal to 30 °C and less than or equal to 50 °C, the voltage control signal Va controls the power supply module 40 to output the first voltage VDD.

It should be additionally noted that the above predetermined range and the non-predetermined range may be adjusted according to an actual situation, and the present application does not impose any limitation here.

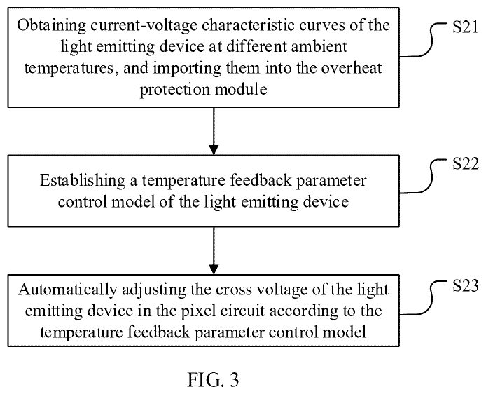

FIG. 3 is a flowchart of a method of changing a cross voltage of a light emitting device according to embodiments of the present disclosure.

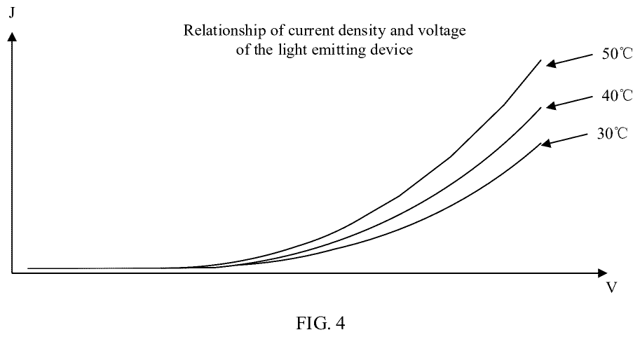

FIG. 4 is a schematic diagram of current density-voltage characteristic curve of a light emitting device according to embodiments of the present disclosure.

As shown in FIG. 3, this method is used, for example, in the overheat protection module 22 of the temperature protection device 20, for performing step S15 in the flowchart of the temperature protection method of FIG. 2b.

In step S21, obtaining current-voltage characteristic curves of the light emitting device at different ambient temperatures as shown in FIG. 4, and importing them into the overheat protection module

In this step, placing the light emitting device at different ambient temperatures in advance to obtain its parameters when working in different ambient temperatures (i.e., current-voltage characteristic curves corresponding to the different ambient temperatures), and importing the curves into the overheat protection module 22.

Exemplarily, the anode of the light emitting device is connected to the positive pole of the DC voltage regulator source, the cathode and of the light emitting device is connected to the negative pole of the DC voltage regulator source. The light emitting device is placed in a test box, and a temperature of the box is adjusted to 30 °C, 40 °C and 50 °C in turn. Each temperature is kept warm for one hour and the power is turned on, and the voltage between the anode and the cathode of the light emitting device is adjusted from 4V to 12V with a step size of 0.1V. Current display values of the OLED device shown by a voltage regulator source is read and recorded at each voltage. The current-voltage between the anode and the cathode (I-V) characteristic curves of the light emitting device at different ambient temperatures are obtained through pointing and plotting with current-voltage pairs of the OLED device under each temperature. Wherein, the above temperature nodes, the voltage ranges and step sizes could be adjusted according to an actual situation, and the present application does not impose any limitation here.

As shown in FIG. 4, in the current-voltage characteristic curves of the light emitting device under different ambient temperatures, when the temperature is the same, the higher the trans-voltage of the light emitting device, the higher the current density of the light emitting device, and vice versa. In a condition of the cross voltages of the light emitting device being the same, the higher the temperature, the higher the current density of the light emitting device. When the ambient temperature of the display device rises, the current of the light emitting device is still maintained in the state before the temperature change by controlling the cross voltage of the light emitting device, so as to reduce the heat generation of the light emitting device.

In step S22, establishing a temperature feedback parameter control model of the light emitting device.

Exemplarily, the temperature feedback parameter control model could be established according to the current-voltage characteristic curves of the light emitting device under different ambient temperatures. When the ambient temperature of the display device rises, calculating and obtaining the corresponding voltage control signal Va. For example, when the ambient temperature increases to 40 °C, calculating and obtaining the corresponding voltage control signal Va to adjust the current of the light emitting device to the current of the light emitting device when normal operating under 30 °C by controlling the first voltage VDD, and so on, when the ambient temperature is 50 °C, performing corresponding process according to the current-voltage between the anode and the cathode (I-V) characteristic curves of the light emitting device.

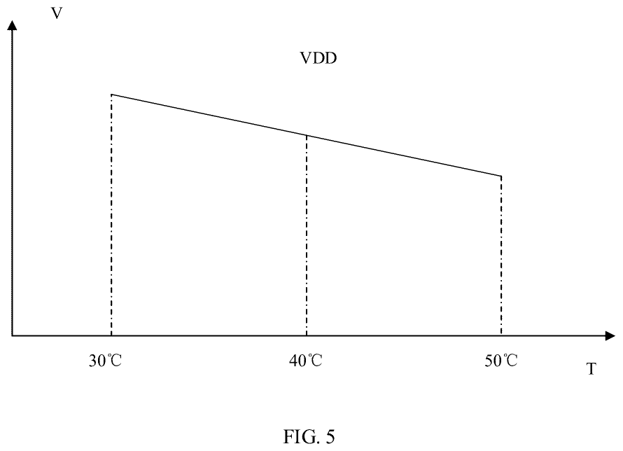

Exemplarily, when the ambient temperature is other values, the corresponding voltage control signal Va could be calculated automatically by linear interpolation to establish the temperature feedback parameter control model of the light emitting device. That is, the control curve corresponding to the relationship of the first voltage VDD changing with the temperature shown in FIG. 5.

In step S23, automatically adjusting the cross voltage of the light emitting device in the pixel circuit according to the temperature feedback parameter control model.

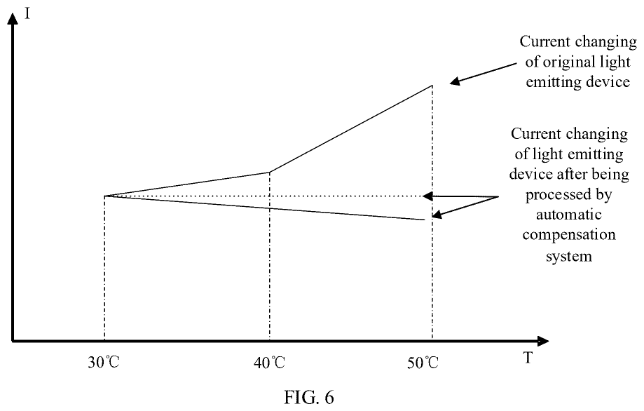

FIG. 5 is a control model curve of a first voltage VDD changing with temperature according to embodiments of the present disclosure; FIG. 6 is a schematic diagram of relationship of current changing with time of a light emitting device before and after treatment by a temperature protection device according to embodiments of the present disclosure.

With reference to FIGS. 5 and 6, after establishing the temperature feedback parameter control model of the light emitting device, the corresponding voltage control signal Va could be obtained under different ambient temperatures according to the temperature feedback parameter control model to control the voltage value of the first voltage VDD, so as to control the current of the light emitting device.

Exemplarily, when the ambient temperature rises within the predetermined range, a slope of the relationship of the first voltage VDD changing with the temperature in the temperature feedback parameter control model could be changed, so that the current of the light emitting device after being processed by the temperature protection device is always a constant value within a predetermined temperature range (corresponding to a horizontal dashed line in FIG. 6). Further, the slope of the relationship of the first voltage VDD changing with the temperature could be increased, so that when the temperature rises, the current of the light emitting device is lower than a normal operating current (corresponding to the solid line in FIG. 6 of the change of the current of the light emitting device after treatment by the temperature protection device), so as to realize the protection against overcurrent, inhibit the heating of the light emitting device, and attenuate a vicious cycle in which the ambient temperature further increases while the current increases again.

In a flowchart of the method of changing the cross voltage of the light emitting device of the present embodiment, obtaining current-voltage characteristic curves of the light emitting device in the display device at different ambient temperatures in advance, importing them into the overheat protection module to establish the temperature feedback parameter control model of the light emitting device, and then obtaining the corresponding voltage control signal Va under different ambient temperatures with reference to the temperature feedback parameter control model to control a voltage value of the first voltage VDD, so as to control the current of the light emitting device. In a preferred embodiment, the slope of the relationship of the first voltage changing with temperature in the temperature feedback parameter control model is changed, so as to realize constant current control or overcurrent control of the light emitting device.

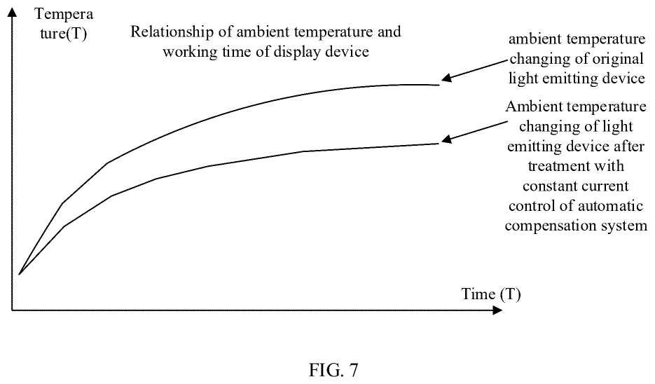

FIG. 7 is a schematic diagram of relationship of an ambient temperature changing with time of a display device before and after treatment with constant current control of a temperature protection device according to embodiments of the present disclosure.

As shown in FIG. 7, after treatment with constant current control of a temperature protection device of the present disclosure, the ambient temperature of the display device could be stabilized in a lower range relative to before the treatment, reducing a situation in which the display device stops working when the ambient temperature is too high, forcing the system to go into hibernation, and reducing the current of the light emitting device while reducing the power consumption of the display device.

An OLED display device is also provided in an embodiment of the present disclosure, and the above temperature protection device is set in the OLED display device. Specifically, the OLED array in the OLED display device comprises any one of a micro OLED, an active-matrix organic light emitting diode (AMOLED).

It should be noted that a person of ordinary skill in the art will understand that the words “during”, “when”, and “while” as used herein in connection with the operation of the circuit are not strict terms denoting an action that occurs immediately upon initiation of the initiating action, but rather that there may be some small but reasonable delay or delays, such as various transmission delays, etc., between the initiating action and the reaction initiated by the initiating action. The words “approximately” or “essentially” are used herein to mean that the element value has a parameter that is expected to be close to the declared value or position. However, as is well known in the art, there are always small deviations that make it difficult for the value or position to be strictly the stated value. It has been appropriately determined in the art that a deviation of at least ten percent (10%) (at least twenty percent (20%) for semiconductor doping concentrations) is a reasonable deviation from the exact desired goal described. When used in conjunction with a signal state, the actual voltage value or logic state of the signal (e.g., “1” or “0”) depends on whether positive or negative logic is used.

In accordance with the embodiments of the disclosure such as those described above, these embodiments are not exhaustive in all details and do not limit the disclosure to specific embodiments only. Obviously, many modifications and variations may be made in accordance with the above description. These embodiments are selected and specifically described in this specification for the purpose of better explaining the principles and practical applications of the present disclosure, so that those skilled in the said technical field can make good use of the present disclosure as well as the modified use on the basis of the present disclosure. The scope of protection of the present disclosure shall be as defined by the claims of the present disclosure and their equivalents.

1. A temperature protection method in OLED display device, comprising:
detecting an ambient temperature of the display device;
sending a voltage control signal to a power supply module according to a temperature signal that is detected;
wherein when the ambient temperature is in a predetermined range, a first voltage provided by the power supply module to a light emitting device in the display device is adjusted by the voltage control signal.

2. The temperature protection method according to claim 1, further comprising:
controlling the power supply module power-down by the voltage control signal when the ambient temperature is in a non-predetermined range.

3. The temperature protection method according to claim 1, wherein before sending the voltage control signal to the power supply module according to the temperature signal that is detected, further comprises:
obtaining current-voltage characteristic curves of the light emitting device in the display device at different ambient temperatures, and importing them into an overheat protection module;
establishing a temperature feedback parameter control model of the light emitting device;
obtaining a corresponding voltage control signal according to the temperature signal that is detected according to the temperature feedback parameter control model.

4. The temperature protection method according to claim 3, wherein the temperature feedback parameter control model is a control curve of relationship of the first voltage changing with temperature.

5. The temperature protection method according to claim 4, wherein when the ambient temperature rises in the predetermined range, a slope of the relationship of the first voltage changing with temperature is adjusted, and a current of the light emitting device with adjusted first voltage is consistent with a normal operating current.

6. The temperature protection method according to claim 5, wherein on a basis of the current of the light emitting device with adjusted first voltage is consistent with the normal operating current, the slope of the relationship of the first voltage changing with temperature is increased, and the current of the light emitting device with adjusted first voltage is less than the normal operating current.

7. The temperature protection method according to claim 2, wherein the predetermined range is greater than or equal to 30 °C and less than or equal to 50 °C, and the non-predetermined range is greater than 50 °C.

8. The temperature protection method according to claim 3, wherein a step of establishing the temperature feedback parameter control model of the light emitting device comprises: placing the light emitting device in different ambient temperatures in advance to obtain its parameters when working in different ambient temperatures.

9. A temperature protection device in OLED display device, comprising:
a temperature detection element and an overheat protection module,
the temperature detection element is configured to detect an ambient temperature of the display device, and send a temperature signal that is detected to the overheat protection module;
the overheat protection module is configured to send a voltage control signal to a power supply module according to the temperature signal that is detected, and adjust a first voltage provided by the power supply module to a light emitting device in the display device by the voltage control signal.

10. An OLED display device, comprising a temperature protection device in OLED display device according to claim 9, wherein an OLED array in the OLED display device comprises any one of micro OELD and AMOLED.
